(19) United States
(12) Patent Application Publication
(10) Pub. No.: US 2021/0384499 A1
(43) Pub. Date: Dec. 9, 2021

(54) METHOD FOR PRODUCING ACTIVE MATERIAL

(71) Applicant: TOYOTA JIDOSHA KABUSHIKI KAISHA, Toyota-shi (JP)

(72) Inventors: Tetsuya WASEDA, Susono-shi (JP); Jun YOSHIDA, Mishima-shi (JP); Hiroyuki KAWAURA, Nagakute-shi (JP); Yasuhito KONDO, Nagakute-shi (JP); Ryo SUZUKI, Nagakute-shi (JP); Hiroyuki NAKANO, Nagakute-shi (JP); Nobuhiro OGIHARA, Nagakute-shi (JP)

(73) Assignee: TOYOTA JIDOSHA KABUSHIKI KAISHA, Toyota-shi (JP)

(21) Appl. No.: 17/333,632

(22) Filed: May 28, 2021

(30) Foreign Application Priority Data
Jun. 4, 2020 (JP) 2020-097650
May 27, 2021 (JP) 2021-089171

(51) Int. Cl. H01M 4/38; C01B 33/02

(52) U.S. Cl. CPC H01M 4/386; C01P 2004/03; C01P 2006/40; C01B 33/02

(57) ABSTRACT

A main object of the present disclosure is to provide a method for producing an active material with a high productivity. The present disclosure achieves the object by providing a method for producing an active material, the method comprising steps of: a preparing step of preparing a dope solution including a metal ion that is an ion of a metal element M, and an aromatic hydrocarbon compound in a reduced condition, a precursor alloy producing step of producing a precursor alloy by doping the metal element M included in the dope solution to a Si raw material including a Si element, and a void forming step of forming a void by extracting the metal element M from the precursor alloy using an extracting agent.

### TECHNICAL FIELD

The present disclosure relates to a method for producing an active material.

### BACKGROUND ART

In recent years, the development of a battery has been actively carried out. For example, the development of a battery and an active material used for a battery, used for an electric automobile or a hybrid automobile has been advanced in the automobile industry.

As a high-capacity active material used for a battery, a porous silicon particle is known. For example, Patent Literature 1 discloses a method for producing a porous silicon particle, the method comprising a step of producing a silicon intermediate alloy, a step of separating into a silicon fine particle and a second phase by immersing the silicon intermediate alloy into a molten metal of a molten metal element, and a step of removing the second phase.

### CITATION LIST

### Patent Literature

Patent Literature 1: Japanese Patent Application Laid-Open (JP-A) No. 2012-082125

### SUMMARY OF DISCLOSURE

### Technical Problem

The theoretical capacity of Si as an active material is 4199 mAh/g, and is approximately 10 times the value compared to the theoretical capacity of graphite (372 mAh/g), which is a common active material, so that a battery with higher capacity and higher energy density is expected. Meanwhile, since the volume variation due to charge/discharge of a battery of Si is large, the cycle property, for example, is likely to be lowered. In contrast to this, since the porous silicon particle includes a void inside thereof, the volume variation due to charge/discharge is easily suppressed.

In Patent Literature 1, for example, the porous silicon particle is produced by using the molten metal. However, since a large heating device is usually necessary for obtaining the molten metal, the productivity is low. The present disclosure has been made in view of the above circumstances, and a main object of the present disclosure is to provide a method for producing an active material with a high productivity.

### Solution to Problem

In order to achieve the object, the present disclosure provides a method for producing an active material, the method comprising steps of: a preparing step of preparing a dope solution including a metal ion that is an ion of a metal element M, and an aromatic hydrocarbon compound in a reduced condition, a precursor alloy producing step of producing a precursor alloy by doping the metal included in the dope solution to a Si raw material including a Si element, and a void forming step of forming a void by extracting the metal element M from the precursor alloy using an extracting agent.

According to the present disclosure, an active material (porous Si based active material) may be produced with high productivity by producing a precursor alloy (SiM based alloy) by using a predetermined dope solution, and extracting the doped metal from the precursor alloy.

In the disclosure, the metal element M may be at least one kind of Li, Na, Mg and K.

In the disclosure, the metal element M may include at least Li.

In the disclosure, the aromatic hydrocarbon compound may be at least one kind of naphthalene, biphenyl, ortho-terphenyl, anthracene, and para-terphenyl.

In the disclosure, the dope solution may include at least one kind of tetrahydrofuran, dimethoxyethane, dioxolane, and dioxane, as a solvent.

In the disclosure, the extracting agent may be at least one kind of ethanol, butanol, and hexanol.

In the disclosure, the preparing step may be a step of preparing the dope solution by mixing a solvent, a metal raw material including the metal element M, and the aromatic hydrocarbon compound.

### Advantageous Effects of Disclosure

The present disclosure exhibits an effect that an active material may be produced with high productivity.

### BRIEF DESCRIPTION OF DRAWINGS

FIG. 1 is a flow diagram illustrating an example of a method for producing an active material in the present disclosure.

FIG. 2 is SEM image of the anode active material obtained in Example 1.

FIG. 3 is the result of a fine pore distribution measurement for the anode active material obtained in Example 1.

### DESCRIPTION OF EMBODIMENTS

A method for producing an active material in the present disclosure will be hereinafter described in detail.

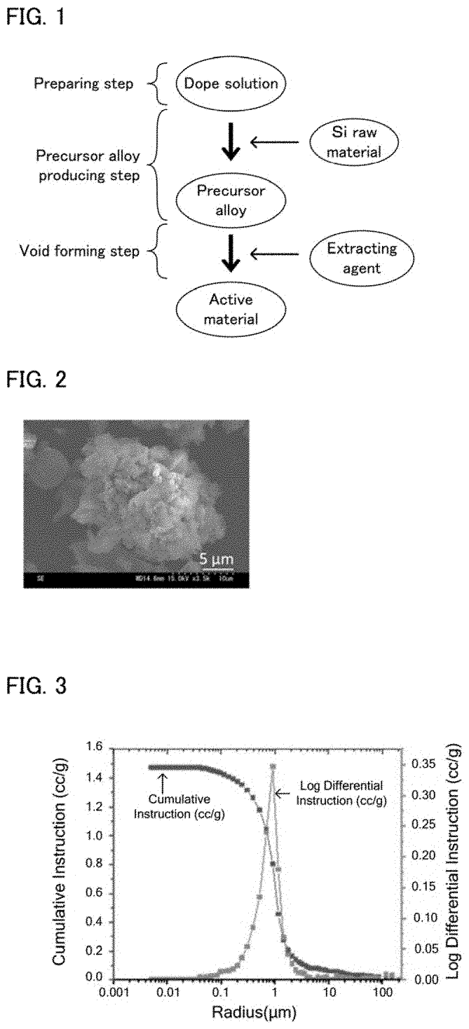

FIG. 1 is a flow diagram illustrating an example of a method for producing an active material in the present disclosure. At first, a dope solution including a metal ion that is an ion of a metal element M (M ion), and an aromatic hydrocarbon compound in a reduced condition is prepared (preparing step). Next, a precursor alloy (SiM based alloy) is produced by doping the metal element M included in the dope solution to a Si raw material including a Si element (precursor alloy producing step). Then, a void is formed by extracting the metal element M from the precursor alloy using an extracting agent (void forming step). As described above, an active material (porous Si based active material) is produced.

According to the present disclosure, an active material (porous Si based active material) may be produced with high productivity by producing a precursor alloy (SiM based alloy) by using a predetermined dope solution, and extracting the doped metal element from the precursor alloy. Patent Literature 1 discloses a method for producing a porous silicon particle. In the method for producing described in Patent Literature 1, the silicon fine particle and the second phase are separated by immersing the silicon intermediate alloy into a molten metal of a molten metal element. A large equipment is necessary in such a method carrying out the deposition of silicon (Si) in a high-temperature molten metal (in melted metal). Meanwhile, in the method for producing in the present disclosure, since the metal is doped to the Si raw material by using the dope solution, and the metal element is extracted from the precursor alloy using the extracting agent, a large equipment is not necessary. Also, when silicon is deposited under high temperature as in Patent Literature 1, a by-product of the reaction between Si and an intermediate element may be generated. And the electrochemical property of the obtained active material may be deteriorated by the by-product. Meanwhile, in the present disclosure, since the metal element is extracted by using the extracting agent, a high-temperature environment is not necessary. Therefore, not only the productivity is high, but also there is no fear that the electrochemical property of the active material is deteriorated by the by-product generated under high temperature.

1. Preparing Step

The preparing step in the present disclosure is a step of preparing a dope solution including a metal ion that is an ion of a metal element M, and an aromatic hydrocarbon compound in a reduced condition.

The dope solution includes a metal ion (M ion) that is an ion of the metal element M. The metal element M is a metal to be doped to the Si raw material in the precursor alloy producing step to be described later. The metal element M is not particularly limited as long as it capable of being alloyed with Si, and examples thereof may include metal elements such as an alkali metal and an alkaline earth metal. Examples of the alkali metal may include Li, Na and K. Examples of the alkaline earth metal may include Mg and Ca. The dope solution may include only one kind of the metal element M, and may include two kinds or more of the metal elements M.

Here, the active material in the present disclosure is usually used for a battery. Therefore, it is preferable to select the metal element M according to the type of the battery. For example, when the active material in the present disclosure is used for a lithium ion battery, at least Li is preferably selected as the metal element M. Also, when the active material in the present disclosure is used for a sodium ion battery, at least Na is preferably selected as the metal element M.

The dope solution includes an aromatic hydrocarbon compound in a reduced condition. An aromatic hydrocarbon compound in a reduced condition refers to an aromatic hydrocarbon compound present as an anion (including a radical anion). The aromatic hydrocarbon compound is a compound with an aromatic ring. Examples of the aromatic ring may include a five-membered ring, a six-membered ring, and an eight-membered ring, and a six-membered ring is preferred. The aromatic hydrocarbon compound may be a monocyclic compound including one aromatic ring, and may be a polycyclic compound including two or more aromatic rings, and the latter is preferred. Examples of the polycyclic compound may include an aromatic polycyclic compound such as biphenyl wherein aromatic rings are bonded; and a condensed polycyclic compound such as naphthalene and anthracene wherein aromatic rings are condensed. Also, in the polycyclic compound, the number of aromatic rings is 2 or more, and may be 3 or more. On the other hand, the number of aromatic rings is, for example, 5 or less. As the aromatic hydrocarbon compound in the present disclosure, naphthalene, biphenyl, ortho-terphenyl, anthracene, and para-terphenyl are preferable. Among them, naphthalene and biphenyl are particularly preferred.

The dope solution may include only one kind of aromatic hydrocarbon compound, and may include two kinds or more of aromatic hydrocarbon compounds. Also, a part of the aromatic hydrocarbon included in the dope solution may be present in a reduced condition, and all of them may be present in the reduced condition.

The dope solution usually includes M ion (cation) and the aromatic hydrocarbon compound in a reduced condition (anion) as a reactant of the two. For example, when the metal element M includes Li and the aromatic hydrocarbon compound includes naphthalene, the dope solution includes lithium naphthalenide which is the reactant of the two.

Also, the dope solution may include a solvent. The solvent is not particularly limited as long as it does not react with the metal element M, and examples thereof may include tetrahydrofuran, dimethoxyethane, dioxolane and dioxane. The dope solution may include only one kind of solvent, and may include two kinds or more solvents.

The concentration of the metal ion (M ion) in the dope solution is, for example, 0.05 mol/L or more and 3 mol/L or less. Also, the concentration range of the aromatic hydrocarbon compound in the dope solution is the same as the concentration range of the above-mentioned metal ion. Here, in the dope solution, the concentration of the metal ion and the aromatic hydrocarbon compound may be equal, and may be different. In the latter case, the concentration of the metal ion may be higher, and may be lower.

Also, the dope solution may be commercially purchased, and may be prepared by oneself. In the latter case, preparing step in the present disclosure may be a step of mixing a solvent, a metal raw material including the metal element M, and the aromatic hydrocarbon compound to prepare the dope solution. Also, the preparing step may be a step wherein the solvent includes at least one kind of tetrahydrofuran, dimethoxyethane, dioxolane and dioxane. The metal raw material only needs to include the metal element M; and examples may include a simple substance of the metal element M and an alloy including the metal element M as a main component.

2. Precursor Alloy Producing Step

The precursor alloy producing step in the present disclosure is a step of producing a precursor alloy by doping the metal element M included in the dope solution to a Si raw material including a Si element.

The Si raw material only needs to include a Si element. Examples thereof may include a simple substance of Si, and a Si alloy including Si as a main component.

The amount of the Si element to 1 mol of the metal ion (M ion) included in the dope solution is, for example, 2 mol or less, may be 1 mol or less, and may be 0.5 mol or less. Meanwhile, to 1 mol of the metal ion (M ion) included in the dope solution, the amount of the Si element is, for example, 0.05 mol or more, may be 0.1 mol or more, and may be 0.2 mol or more. By adjusting the proportion of the metal ion to the Si element, it is possible to adjust the amount of the void in the active material.

Examples of the method for doping the metal element to the Si raw material may include a method wherein a Si raw material is added and reacted to a dope solution. The reaction time is not particularly limited, and is, for example, 1 hour or more, may be 2 hours or more, and may be 4 hours or more. Meanwhile, the reaction time is, for example, 48 hours or less, may be 24 hours or less, and may be 12 hours or less. Also, although the reaction temperature is not particularly limited, room temperature (20° C. or more and 25° C. or less), for example, is preferable.

In the precursor alloy, the proportion of the metal element M to the total of the Si element and the metal element M is, for example, 30 mol % or more, may be 50 mol % or more, and may be 80 mol % or more. When the proportion of the metal element M is too low, a desired volume variation suppressing effect may not be obtained in the active material to be obtained, in some cases. Meanwhile, the proportion of the metal element M is, for example, 95 mol % or less, and may be 90 mol % or less.

3. Void Forming Step

The void forming step in the present disclosure is a step of forming a void by extracting the metal element M from the precursor alloy using an extracting agent. In this step, an active material including a void inside a primary particle is usually obtained.

The kind of the extracting agent is not particularly limited as long as the metal element M may be extracted from the precursor alloy. Examples of the extracting agent may include alcohols such as ethanol, butanol and hexanol. As the extracting agent, only one kind may be used, and two kinds or more may be used. Also, the water content of the extracting agent is preferably low. Water content in extracting agents is, for example, 100 ppm or less, may be 50 ppm or less, may be 30 ppm or less, and may be 10 ppm or less. When the water content is too high, Si may be oxidized so that deterioration of the battery performance is concerned.

The method for extracting the metal to form a void is not particularly limited as long as it is a method wherein the precursor alloy and the extracting agent are brought into contact with each other and reacted. The time for reacting the precursor alloy with the extracting agent is not particularly limited as long as the doped metal element may be sufficiently extracted. The reaction time is, for example, 60 minutes or more, and may be 120 minutes or more. In the void forming step, all of the doped metal elements may be extracted, and a part thereof may be extracted, and the former is preferred.

4. Active Material

The active material obtained in the method for producing in the present disclosure is an active material including a void, and is also referred to as a porous Si based active material.

Examples of the shape of the active material may include a granular shape. The average particle size of the active material is, for example, 0.01 μm or more and 100 μm or less. Incidentally, the average particle size may be determined by observation with a SEM, for example. The number of the sample is preferably large; for example, 20 or more, may be 50 or more, and may be 100 or more. The average particle size may be adjusted appropriately by, for example, appropriately changing the manufacturing conditions of the active material, and by carrying out a classifying treatment.

The void in the active material may have a predetermined average fine pore size (radius). The average fine pore size is, for example, 1 nm or more, may be 10 nm or more, and may be 100 nm or more. Meanwhile, the average fine pore size is, for example, 5 μm or less, may be 3 μm or less, and may be 1 μm or less. The average fine pore size may be determined by, for example, a mercury porosimeter measurement. With an active material having such average fine pore size, the volume variation when storing a carrier ion such as a lithium ion is believed to be suppressed, when such an active material is used for a battery. As the result, it is considered that the cycle property of a battery using such an active material is improved.

Also, the active material in the present disclosure may have a predetermined void ratio. The void ratio is, for example, 10% or more, may be 20% or more, may be 30% or more, may be 40% or more, and may be 50% or more. Meanwhile, the void ratio is, for example, 95% or less, may be 80% or less, and may be 65% or less. The void ratio may be determined by a fine pore distribution measurement using a mercury porosimeter. With an active material having such void ratio, the volume variation when storing a carrier ion such as a lithium ion is believed to be suppressed, when such an active material is used for a battery. As the result, it is considered that the cycle property of a battery using such an active material is improved.

Also, in the active material in the present disclosure, the proportion of the Si element in the total metal elements is, for example, 80 atm % or more, may be 90 atm % or more, and may be 95 atm % or more. Incidentally, the active material may include an element (such as an O element) or a functional group (such as OH group) that may be inevitably included.

The active material in the present disclosure may be a cathode active material, and may be an anode active material. Also, the use of the active material is not particularly limited, and is preferably used for, for example, a lithium ion battery and a sodium ion battery.

### EXAMPLES

### Example 1

<Production of Active Material>

In a glove box in an Ar inert atmosphere, naphthalene was added to a solvent (tetrahydrofuran (THF)) so as to be 1 mol/L and dissolved. Thereafter, a lithium metal equivalent to 1 mol/L was added and stirred, and a deep green doped solution was prepared by the reaction as shown in the following formula (1).

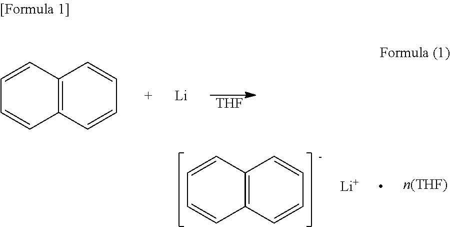

Then, Si simple substance (2 mm to 5 mm lumps, from Kojundo Chemical Lab. Co., Ltd.) was crushed using a mortar in a glove box in an Ar inert atmosphere to obtain a Si raw material. Then, the Si raw material was added to the doped solution (THF solution including 1 mol/L lithium naphthalenide) so as the compounded amount was 0.2 mol/L, and Li was doped to Si by reacting while stirring. Thus, a precursor alloy was produced. Incidentally, the mixture was stirred and reacted for 70 hours. Also, the precursor alloy after the reaction was recovered by filtering the solution after the reaction through a filter paper.

The lithium was then eluted by adding 10 ml of ethanol to the precursor alloy and reacting for 120 minutes. The solid matter after the reaction was recovered, and a porous silicon powder (anode active material) of 20 μm or less was obtained by performing particle size adjustment using a 20 μm sieve.

<Production of Evaluation Battery>

A slurry was produced by mixing 82 weight % of the obtained anode active material, 6 weight % of acetylene black having an average particle size of 2 μm as a conductive material, and 12 weight % of polyimide, adding N-methylpyrrolidone thereto, and stirring. Next, a copper foil having a thickness of 12 μm was coated with the slurry, dried, and rolled to produce an anode electrode having a thickness of 50 μm. The produced anode electrode was punched into a circle having a diameter of 16 mm, and metallic lithium was stacked as a counter electrode on the anode electrode with a porous polyethylene separator interposed therebetween, and the stack was stacked in an evaluation cell (from Nippon Tomuseru K. K.). Further, an electrolyte solution was prepared by adding LiPF₆ to a mixed solvent including ethylene carbonate (EC)/dimethyl carbonate (DMC)/ethyl methyl carbonate (EMC) at a volume ratio of 3/4/3, so as to be a concentration of 1 mol/L. By injecting this electrolyte solution into the evaluation cell, an evaluation battery (lithium ion battery), which is a half-cell, was produced.

### Example 2

An anode active material and an evaluation battery were produced in the same manner as in Example 1, except that Si simple substance (average particle size: 5 μm, from Kojundo Chemical Lab. Co., Ltd.) was used as the Si raw material.

### Example 3

An anode active material and an evaluation battery were produced in the same manner as in Example 1, except that Si simple substance (average particle size: 2 μm, from Kojundo Chemical Lab. Co., Ltd.) was used as the Si raw material.

### Example 4

An anode active material and an evaluation battery were produced in the same manner as in Example 1, except that the Li dope solution was prepared by using biphenyl, instead of naphthalene. Incidentally, the Li dope solution in Example 4 may be obtained by the reaction shown in Formula 2 below.

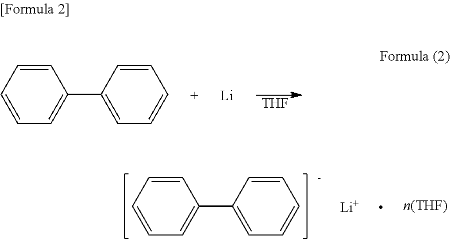

### Comparative Example 1

An evaluation battery was produced in the same manner as in Example 1, except that Si simple substance (average particle size: 5 μm, from Kojundo Chemical Lab. Co., Ltd.) was used as the anode active material.

[Evaluation]

<Microscope Observation>

The anode active material obtained in Example 1 was observed with a microscope using a scanning electron microscope (SEM). The obtained SEM image is shown in FIG. 2. As shown in FIG. 2, it was confirmed that a granular active material may be produced by the method for producing in the present disclosure.

<Fine Pore Distribution Measurement>

The anode active material obtained in Example 1 was subjected to a fine pore distribution measurement by a mercury porosimeter. Washburn method was used for the analysis. The results are shown in FIG. 3. As shown in FIG. 3, the fine pore size had a distribution of 200 nm to 1.5 μm, and the void ratio was 73%. Also, as may be seen in the SEM image shown in FIG. 2, the average fine pore size was approximately 1 μm.

<Cycle Test>

The evaluation batteries obtained in Examples and Comparative Example 1, were repeatedly charged and discharged for 10 cycles at the current density of 0.2 C in the battery voltage range of 0 V to 1.5 V. The capacity durability after 10 cycles was determined from the initial discharge capacity and the discharge capacity after 10 cycles. The results are shown in Table 1.

TABLE 1

| | Initial | Discharge | Capacity |
|---|---|---|---|
| | discharge | capacity | durability |
| | capacity | after 10 cycles | after 10 cycles |
| | (mAh/g) | (mAh/g) | (%) |
| Example 1 | 1720 | 1516 | 88.2 |
| Example 2 | 1860 | 1712 | 92.0 |
| Example 3 | 1850 | 1725 | 93.2 |
| Example 4 | 1752 | 1529 | 87.3 |
| Comp. Ex. 1 | 1937 | 494.8 | 25.5 |

As shown in Table 1, for the evaluation batteries in Examples 1 to 4, the capacity durability was high as 87% to 93%. Meanwhile, the capacity durability in Comparative Example 1 was low as 26%. From these results, it was confirmed that an active material having good capacity durability may be produced with a high productivity in the method for producing in the present disclosure.

What is claimed is:

1. A method for producing an active material, the method comprising steps of:
a preparing step of preparing a dope solution including a metal ion that is an ion of a metal element M, and an aromatic hydrocarbon compound in a reduced condition,
a precursor alloy producing step of producing a precursor alloy by doping the metal element M included in the dope solution to a Si raw material including a Si element, and
a void forming step of forming a void by extracting the metal element M from the precursor alloy using an extracting agent.

2. The method for producing an active material according to claim 1, wherein the metal element M is at least one kind of Li, Na, Mg and K.

3. The method for producing an active material according to claim 2, wherein the metal element M includes at least Li.

4. The method for producing an active material according to claim 1, wherein the aromatic hydrocarbon compound is at least one kind of naphthalene, biphenyl, ortho-terphenyl, anthracene, and para-terphenyl.

5. The method for producing an active material according to claim 4, wherein the aromatic hydrocarbon compound is at least one kind of naphthalene, and biphenyl.

6. The method for producing an active material according to claim 1, wherein the dope solution includes at least one kind of tetrahydrofuran, dimethoxyethane, dioxolane, and dioxane, as a solvent.

7. The method for producing an active material according to claim 1, wherein the extracting agent is at least one kind of ethanol, butanol, and hexanol.

8. The method for producing an active material according to claim 1, wherein the preparing step is a step of preparing the dope solution by mixing a solvent, a metal raw material including the metal element M, and the aromatic hydrocarbon compound.
